(19) United States
(12) Patent Application Publication
(10) Pub. No.: US 2012/0124029 A1
(43) Pub. Date: May 17, 2012

(54) CROSS MEDIA KNOWLEDGE STORAGE, MANAGEMENT AND INFORMATION DISCOVERY AND RETRIEVAL

(76) Inventor: Shashi Kant, Cambridge, MA (US)

(21) Appl. No.: 13/196,639

(22) Filed: Aug. 2, 2011

Related U.S. Application Data
(60) Provisional application No. 61/370,092, filed on Aug. 2, 2010.

(51) Int. Cl. G06F 17/30

(52) U.S. Cl. 707/715; 707/E17.017; 707/E17.044; 707/E17.002

(57) ABSTRACT

A System, method and application for creating comprehensive multiple mixed media knowledge storage and management, discovery and retrieval utilizing novel indexing and querying applied to content from multiple media formats from disparate sources is disclosed. Depending on the media format the system breaks down the source information in any media into constituent units (“tokens”) using a reference corpus of labeled tokens (“training set”). The details of tokens are stored in an inverted index with available reference data such as location in the file, time, source file and additional information related to the token such as quantitative similarity to the best-match token(s) in the training set etc. During retrieval, a query comprising of single element in any media; a multimedia element or a combination of such elements including a sequence of such elements in a time line is similarly broken down into constituent units to generate a novel query structure. This enables discovery and retrieval of knowledge from multiple source documents in different media combined to provide results which could include prediction of events; discovery of events leading up to or contributing to an outcome of interest and retrieval of documents or sections thereof, all ordered by relevance depending on the query and its context.

### CROSS-REFERENCE TO RELATED APPLICATION

This application claims the benefit of U.S. Provisional Application No. 61/370,092, filed Aug. 2, 2010, which is herein incorporated by reference.

### BACKGROUND

1. Field of the Invention

The present invention relates generally to information access and retrieval, which can include combining information and knowledge in varied forms and from disparate sources into a single knowledge management system that includes storage, discovery and more particularly, to information retrieval systems for discovery of most concise and relevant answers from large volumes of cross media information.

2. Background of the Invention

Current approaches to querying textual or non-textual content such as audio, videos, images etc. typically rely on using text analysis or matching text metadata such as name or description tags, date-time and other information related to the non textual data files. There have been some approaches proposed using content-based analysis.

### SUMMARY OF THE INVENTION

The present invention, in one general aspect, offers a novel way to fuse multi-modal information for creating a combined knowledge base for building comprehensive knowledge management systems allowing complete review, analysis, discovery and retrieval of extracted elements that can be combined into a coherent response to a highly nuanced query. These systems are capable of ingesting information in multiple media formats: text, video, structured data etc. This approach to knowledge management enables a novel way of creating automated solutions to complex, dynamic, inter-related, multi-dimensional problems utilizing knowledge from disparate data sources, formats and media that are currently commonly addressed by humans.

The present invention can enable efficient analysis of multi-modal datasets and associated metadata. It is capable of working with data in any media format: video, images, audio, text and numeric and is cross-media. Unlike comparable multimedia analysis systems that include video content analysis technologies, this approach enables integration of information from multiple sources (including video) into a unified inverted index format effectively combining all cross-media information into a single knowledge base. This approach provides for advanced query construction from cross media elements combined to create formulations such as: Boolean Queries, Nested Queries, Fuzzy Queries etc. including multi-modal queries with these elements in a time sequence. The combination of “search-engine” like interface, and ability to work with data across media, provides the users with a familiar yet unique and powerful mechanism for interaction with a single knowledge base combining complex mixed media data sources.

The following basic characteristics define this approach:
a. Integration of previously stored information and new information streaming in from multiple sources in different media such as Video, Images, Audio, Textual and Numerical forms into a unified format that can be queried in conjunction, for enabling the clearest possible comprehensive automated analysis.
b. Use of content-based interpretation mechanisms such that information is interpreted using intrinsic data, therefore obviating the necessity for metadata such as tagging, manual interpretation or classification; but also utilizing metadata as and when available.
c. Unique powerful query mechanism to find multiple potential sequence of events (each with a measure of confidence) leading to the event or outcome under consideration and included in the query or constructing and predicting probability of a range of future event outcomes with associated likelihood measure utilizing the system for developing sequence of information from different sources to determine a measure of likelihood/probability of each such outcome.
d. Unique powerful query mechanism for constructing and predicting probability of a range of future event outcomes with associated likelihood measure in real time response to changing scenarios provided via a query mechanism designed for creating such varied scenarios and studying the impact of changes in each scenario presented by the user.

In one general aspect, the invention features a mixed media search system that includes a first medium preprocessor responsive to digitally stored documents that are encoded according to a first media format. The first medium preprocessor includes logic operative to extract symbolic attributes from dimensionally variable information in the first media format. An indexer is responsive to the first preprocessor and is operative to build an index that includes entries associated with symbolic attributes extracted by the first preprocessor. A query interface is responsive to a user query and operative to execute the query against the index that includes the entries derived from symbolic attributes extracted by the first preprocessor.

In preferred embodiments, the apparatus can include a second medium preprocessor responsive to digitally stored documents, that are encoded according to a second media format, wherein the second medium preprocessor includes logic operative to extract symbolic attributes from information in the second media format. The indexer can be responsive to both the first and second preprocessors and can be operative to build an index that includes entries associated with both symbolic attributes extracted by the first preprocessor and symbolic attributes extracted by the second preprocessor. The query interface can be operative to execute the query against the index that includes the entries derived from both symbolic attributes extracted by the first preprocessor and symbolic attributes extracted by the second preprocessor. The apparatus can further include a third medium preprocessor responsive to digitally stored documents that are encoded according to a third media format, with the third medium preprocessor including logic operative to extract symbolic attributes from continuously variable information in the third media format, with the indexer being further responsive to the third medium processor and being operative to build an index that includes entries that are associated with symbolic attributes extracted by the third preprocessor. The first medium preprocessor can be a video preprocessor, the second medium preprocessor can be a textual document preprocessor, and the third medium preprocessor can be a still image preprocessor. The first medium preprocessor can be a video preprocessor and the second medium preprocessor is a textual document preprocessor. The first preprocessor can be further operative to extract metadata from stored documents that are encoded according to the first media format. The second preprocessor can be operative to extract the symbolic attributes from information in the second media format in the form of metadata from stored documents that are encoded according to the second media format. The apparatus can further include a media format detector that is operative to detect at least the first and second media formats in a received document and that is operative to provide a signal identifying a detected media format in the received document to enable the selection of one of the media preprocessors for preprocessing the received document. The first medium preprocessor can be a video preprocessor that is operative to extract visual primitive information from frames of video material from a digitally stored document. The apparatus can further include sequence detecting logic operative to detect information in sequences of video frames. The first medium preprocessor can be a video preprocessor that is operative to match reference frames with frames of video material from a digitally stored document. The first medium preprocessor can be an audio preprocessor that includes voice recognition logic operative to extract textual information from a digitally stored document that includes audio-encoded information. The apparatus can further include a manual review interface operative to associate manually generated attribute information with a digitally stored document. The query interface can further include media-specific query preprocessing logic operative to boost query terms based on medium type information for the query terms. The dimensionally variable information can include one of spatially, temporally, mechanically, and electromagnetically variable information. The dimensionally variable information can include continuously variable information. The system can be operative to associate probabilistic information with extracted symbolic attributes. The system can be operative to associate confidence information with extracted symbolic attributes.

Embodiments of the current invention can provide an innovative mechanism to account for multiple descriptors and related variants, to be quantitatively associated with multiple entities within source media across both spatial and temporal dimensions, thus providing for maximizing the F-measure in information retrieval. This is in contrast to other proposed systems that employ content-based analysis approaches that can fall short since they do not address the issue of combining and analyzing data from all sources irrespective of the source media without problematic restrictions and limitations. Embodiments of the current invention also stand in contrast with prior approaches that fail to account for inherent linguistic ambiguities such as synonymy, homonymy, and polysemy etc.

### BRIEF DESCRIPTION OF THE DRAWINGS

FIG. 1a is an overall schematic of an embodiment of the present invention (flowchart of video content indexing). Input stored or streaming video is converted into a string of image frames. Each frame and its content is compared with the library of tagged images or labeled features available in the Tagged Image Set. All matches and the measure of such match are stored in the Textual Representation. All such textual representations are then indexed into a common index.

FIG. 1b provides details of preprocessing (flowchart of video content pre-processing). Preprocessing includes the manual step of tagging any frames or features that were not matched to the existing tags or labels in the library of tagged images.

FIG. 1c shows process for Textual Representation (flowchart of textual representation of frame). First features are identified within each frame. These features are matched with images in the library of tagged images to extract the textual tag or label or any other information associated with the feature. Identified features that do not match any of the library features are presented for manual tagging. All auto and manually generated descriptions are combined with the original image feature in the Textual Representation that is then created.

FIG. 1d is an example of an extracted feature with multiple tags or labels associated with it (multiple descriptors attached to a single object).

FIGS. 2a-2b show a flow chart for the indexing process (a: inverted indexing schematic from developer. apple.com; b: flowchart of tokenization from “Lucene in Action,” Manning Publications 2004). In the first step of this process, stop words similar to those shown in the schematic are identified and removed. The remaining terms are placed in the inverted index with a unique identifier, a count of the term's occurrence in different documents.

FIG. 3 is the schematic of an indexing process.

FIG. 4 is a flowchart of the example multimedia querying process.

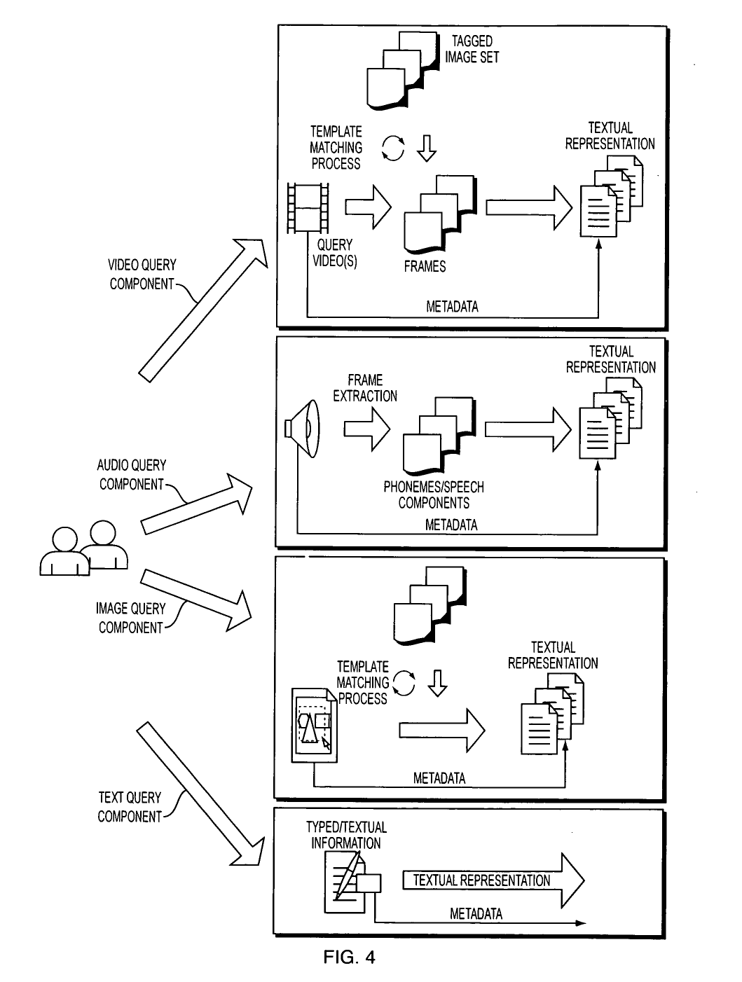

FIG. 5 is a schematic for indexing relational data such as those from sensors, communication devices etc.

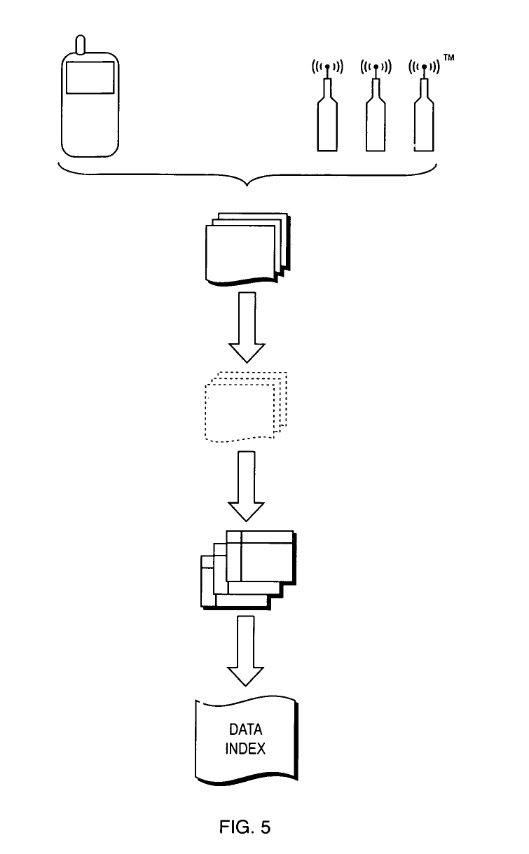

FIG. 6 is a schematic for indexing video data (FMV). This process also includes the process for indexing static images.

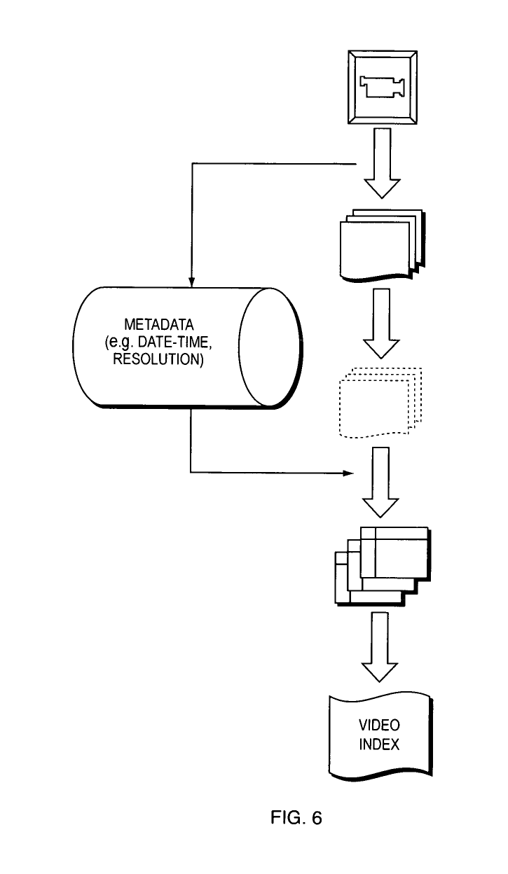

FIG. 7 is a schematic for indexing textual information such as those in Microsoft Word documents, emails, text messages.

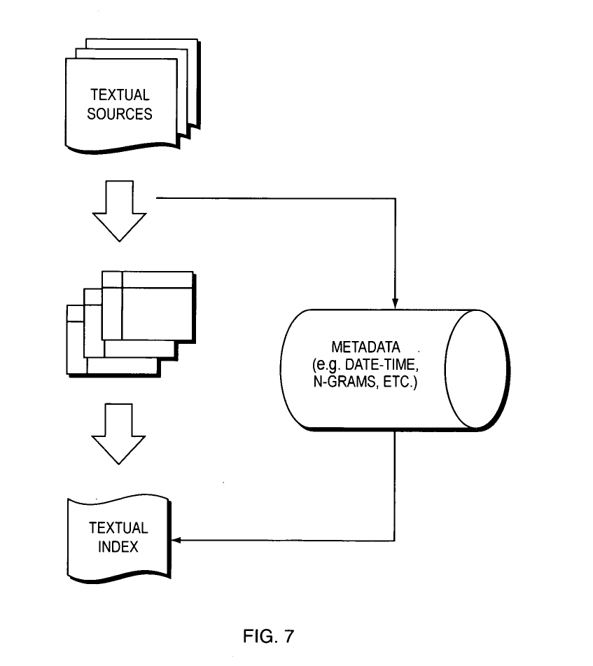

### DETAILED DESCRIPTION OF ILLUSTRATIVE EMBODIMENTS

### I. Overview

The proposed system of comprehensive knowledge management is constituted of modules for 1. handling of incoming source data in the different media; 2. combining it into a single knowledgebase by creating a common inverted index and then 3. enabling highly flexible and nuanced queries for obtaining predictive, diagnostic and what-if analysis type responses generated from the single knowledgebase. Modules for handling each media are explained in detail along with the process for creating queries and the responses. The responses combine most relevant sections from different documents and sources into a single view to provide a complete, concise and relevant response to each query.

In the context of this invention, a “document” is an object or representation of a collection of fields relevant to the information being processed. This might include field-values from multiple sources, tables etc. A Document is thus the unit of search and index. An index consists of one or more Documents, Indexing involves adding Documents to an index, and searching involves retrieving Documents from it. A Document doesn't necessarily have to be a document in the common English usage of the word. For example, for creating an index of a database table of people, then each person and their associated data would be represented in the index as a Lucene Document.

A Document consists of one or more Fields. A Field is simply a name-value pair. For example, a Field commonly found in applications is title. In the case of a title Field, the field name is title and the value is the title of that content item. Indexing in Lucene thus involves creating Documents comprising of one or more Fields, and “writing” these Documents to an index.

### II. Video Indexing

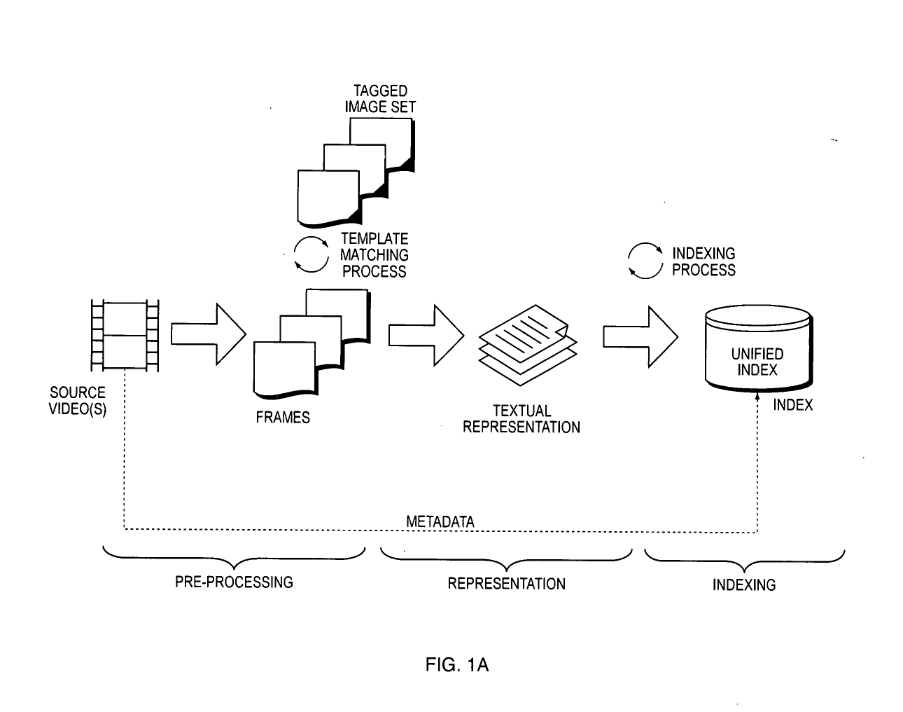

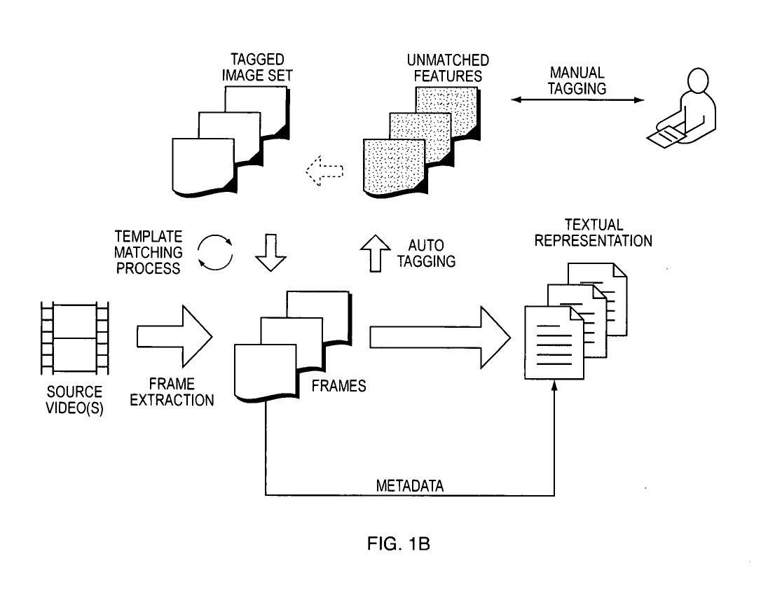

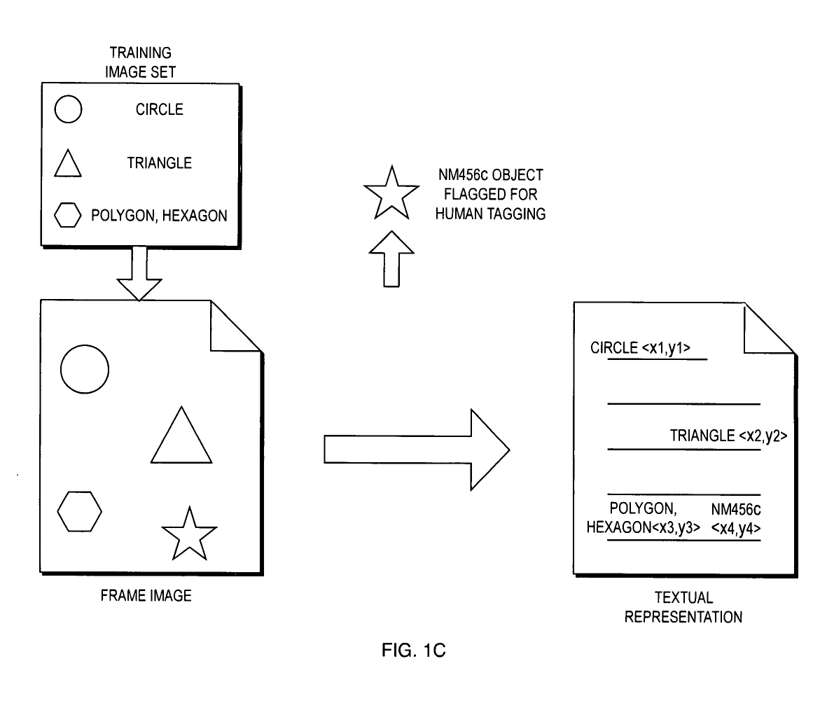

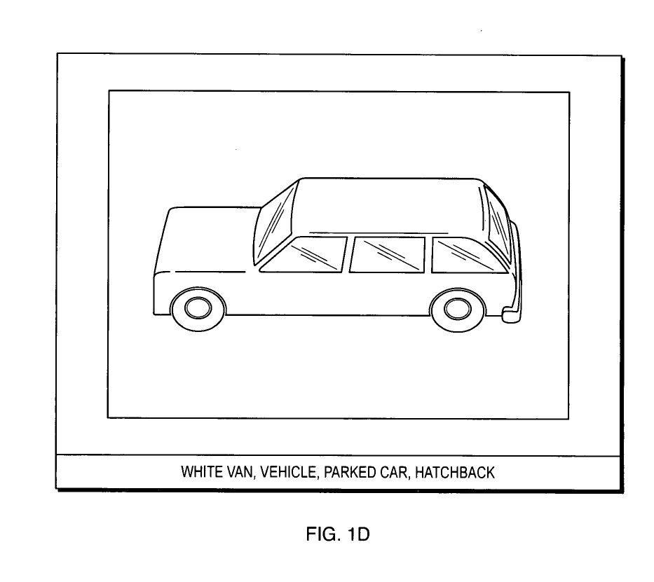

FIG. 1a—illustrates a flowchart for one set of embodiments for processing video files.

### A. Video Pre-processing

Referring to FIG. 1b, one embodiment of video pre-processing is illustrated. The input to video pre-processing is a video file (in any of the standard Video formats) and the output is a set of textual tokens with reference data. Additional optional input is a training corpus with images or video previously tagged manually to provide description and names for features contained therein.

The pre-processing step implements the following:
i. Determine file type: First, the type of video file is determined (AVI, MPEG, WMV etc.). This can be done with processes similar to those for determining the file type of the source document. For example, file extensions or internal data may be used to determine file type.
ii. The video file is converted into a sequence of frames using the appropriate CODEC. The choice of sampling-rates for frames is typically done on a time-based sampling basis. However, in case of rapidly changing events, the sampling rate is changeable to capture events with higher granularity. This sampling rate is also adjustable at any stage to allow for desired level of granularity.
iii. Each individual frame is optionally further segmented into identifiable features. This allows the features that are unmatched against the training corpus to be marked for either human labeling or later automatic (machine-generated) labeling.

### B. Representation

Referring to FIG. 1c, one embodiment of textual representation of a video frame is illustrated.
i. The images in the training corpus are then compared against each image in the frame-set using one or more of approaches such as, but not limited to, template matching, shape matching, color/gray-scale/edge/shape histograms comparison, SURF features (see, e.g., http://www.vision.ee.ethz.ch/˜surf/), etc.
ii. If the matching score exceeds a threshold (user-configurable), the tag(s) (label or metadata) associated with the training image is used to create a textual representation of the frame. The tag is stored in the textual representation corresponding to its location in the frame image.
iii. This process is repeated for all frames extracted from the video file until a representative document is available for each of the extracted frames.
iv. Referring to FIG. 1d multiple descriptors can be associated with a single object and associated measure of fit; vice versa multiple visual objects can be associated with a single descriptor. This many-to-many relationship is represented by custom tokens with token locations corresponding to the geometric location of the object in the frame, and associated quantitative measures captured inherently. To interpret this representation custom tokenizers and analyzers have been developed to write to the inverted index.
v. Frames, or objects therein, for which a suitable representation could not be obtained are flagged for subsequent review by a human reviewer for either manual tagging, rejection or later automatic tagging. Upon manual tagging of the object, the tags are updated to reflect the manual tag.
vi. In the event the objects could not be identified using the training corpus, and is not manually tagged or labeled, the algorithm automatically generates a unique identifier (such as a unique number, unique alphanumeric term, or GUID etc.) for the object and places it in the training corpus for later use.

### III. Audio Indexing

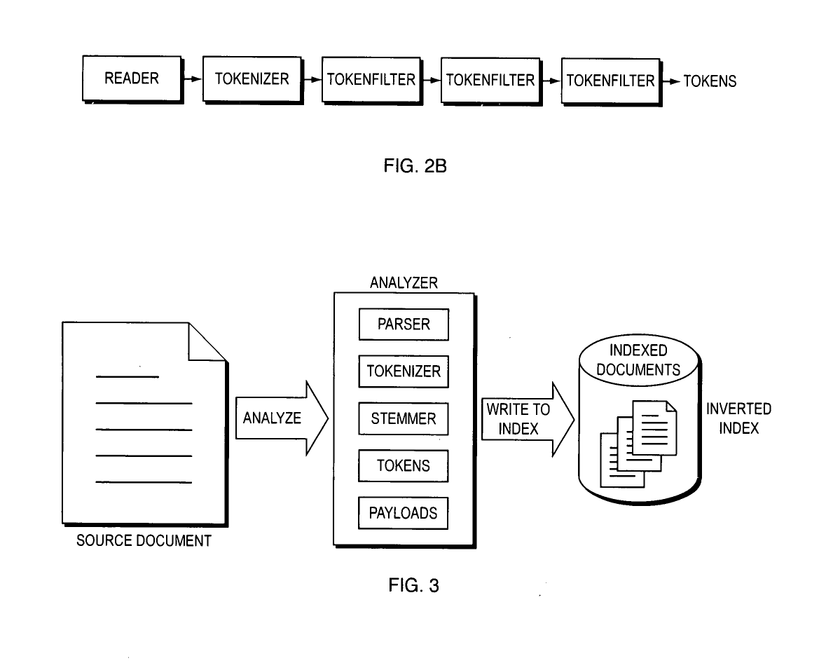

Referring to FIG. 3, which shows a flow-chart of the audio pre-processing operations, as implemented by an audio pre-processing module. The input to audio pre-processing is an audio component and the output is a set of audio tokens with reference data. The audio pre-processing includes the following steps:
i. Determine audio data type: First, the type of the audio data is determined. Methods such as those previously described can be used to determine the type of data (i.e. WAVE, MIDI, and the like), from information such as file extensions, embedded data, or third-party recognition tools.
ii. Speech recognition: Third-party speech recognition software is used to recognize words in the audio data and generate correspondent textual representations is configured to output confidence score for each word, which reflects the level of confidence that the recognized word is correct. This confidence score is stored as metadata associated with the token along with the time offset within the audio data where the word was spoken. This produces a very fine-grain description of precisely where the audio data associated with the word token is within the compound document. This detail is particularly useful during relevancy scoring.
iii. In some instances a recorded word is not recognized at all or the confidence factor is very low. In this case, the speech recognition system preferably produces a list of phonemes, each of which will be used as a token (from a predefined list of standard phonemes). The reference data for these phoneme tokens is the confidence score of the phoneme, and the position of the phoneme within the audio data. Again, this level of reference data facilitates relevancy scoring for the audio data with respect to other audio or other multimedia components.

### IV. Image Indexing

Referring to FIG. 1a, specifically a subset of the chart, whereby template-matching is applied from the training (tagged) image-set to the frames, a similar approach is applied to static images whereby tagged images are matched (using multiple template matching algorithms) with the source image, to generate the corresponding textual representations. These are then input into the indexing process, consisting of multiple descriptors and generated metadata such as confidence measure etc.

### V. Text Indexing

Referring to FIG. 3 source documents in multiple formats such as HTML and variants, Microsoft Office formats including, but not limited to Microsoft Word, Microsoft PowerPoint, Microsoft Excel, Microsoft Access, Microsoft Visio, Microsoft Outlook, ASCII/other formats text files, proprietary file formats such as Adobe PDF, Microsoft XPS etc., are parsed, tokenized, stemmed (if necessary) and indexed using the process defined.

In some cases special filters and access mechanisms are created to extract text tokens from the source documents. Exemplars of such filters include the Microsoft IFilter API or the Apache Tika project (see, e.g., http://tika.apache.org/).

### VI. Multimedia Index

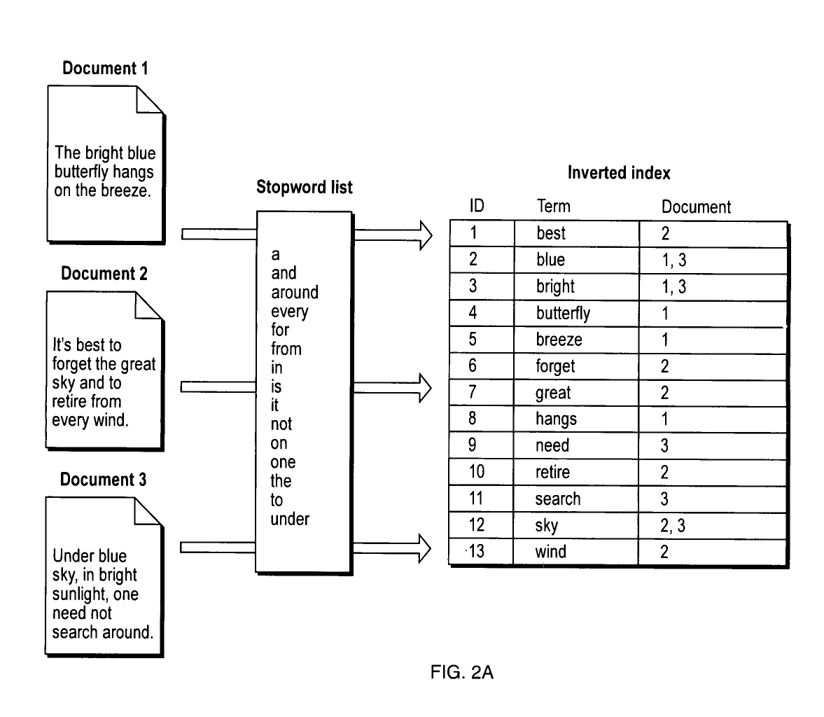

Referring to FIG. 2a, one embodiment of inverted indexing process is illustrated. The input to the process is a set of text representations corresponding to the multimedia sources, such as frames in the video, phonemes in audio etc. and the output is an inverted index which allows for sophisticated query mechanisms. Wikipedia defines an inverted index thus: “An inverted index (also referred to as postings file or inverted file) is an index data structure storing a mapping from content, such as words or numbers, to its locations in a database file, or in a document or a set of documents. The purpose of an inverted index is to allow fast, full and sophisticated look-ups.”

The current invention has been reduced to practice and uses Apache Lucene as the indexing engine and leverages several of its features for implementing the invention as follows:
1. Lucene Payload feature is utilized in order to store metadata and associate it with individual term.
2. A Payload is metadata that can be stored together with each occurrence of a term. This metadata is stored inline in the posting list of the specific term.
3. To store payloads in the inverted index a Token Stream has to be used to produce Tokens containing payload data. Payloads in Lucene include the position of terms, and go one step further: namely, a Payload in Apache Lucene is an arbitrary byte array stored at a specific position (i.e. a specific token/term) in the index.
   A Lucene payload is used in this manner to store weights for specific terms extracted by the various matching algorithms along with other semantic information relevant to the disclosed invention.

### VII. Multimedia Index Operations

### A. Query Pre-Processing

i. A query could constitute one or more media elements such as: new video, selected image or sub-image, text query etc. The multiple elements are reduced to a uniform textual representation as in the indexing process.
ii. The textual representation also stores metadata at a term level corresponding to the quantitative measure obtained during generation of textual representation. These measures are used to “boost” query terms/phrases correspondingly.
iii. Similarly for given objects, all available textual representations (exceeding a certain threshold) are used to generate the query.
iv. This approach provides for advanced query approaches such as: Boolean Queries (e.g., “White Van” AND “armed group”), Nested queries (e.g., (white van AND pickup truck) OR (“armed group” AND pickup truck)), Fuzzy Queries etc. and multi-modal query formulations (e.g., truck image AND crowd image with location Kandahar), simultaneously allowing for predictive and diagnostic modes of reasoning. The combination of “search-engine” like interface, and ability to work with data across media, provides the users with a familiar yet powerful interaction mechanism.

### B. Query Execution

The query is executed on the index and the results are ordered by relevance calculated by both the term-level metadata applied at index time, and the boosts applied at query time. This allows for highest possible Precision-Recall tradeoff: the F-measure.

### C. Time Sequence Query

This is a query built using a series of events along a specified timeline. An example use for this is in Activity detection in Full-motion video (FMV). This is an active area of research and an essential feature for various situations such as surveillance, forensic analysis and alert systems etc. The proposed innovation allows for time sequence query for activity detection in audio and video, or a sequence of images, but is described specifically in an FMV context.
i. In order to detect activity such as “man exiting vehicle”, “person loitering”, “people entering building” etc. the metadata associated with concepts such as “man” or “vehicle” provides a sequence of locations for detecting activity.
ii. An activity is defined during the time sequence query generation process that provides an example for the system to query for. Corresponding textual representations for the activity are generated and the following steps initiated:
iii. A Span Query is generated corresponding to the activity in question. Spans provide a proximity search feature to Lucene. They are used to find multiple terms near each other without requiring the terms to appear in a specified order. It is possible to configure terms to find how close they must be, or if they are within a certain specified distance from each other. Such queries can be combined with each other, or other queries, for more sophisticated detection mechanisms.
iv. An n-gram based approach is used to further filter out noise and improve the accuracy of the results. An n-gram is a subsequence of n items from a given sequence. The items in question can be phonemes, syllables, letters, words or base pairs depending upon the application. This would allow objects frequently seen in proximity to be each other and recognize activity. For example, “car next to a building”, or “person next to vehicle”, is much more probable than a “giraffe next to a building”. This approach allows for weeding out false matches and improves overall system accuracy.

The system combines the components including the pre-processing and indexing of all forms of data including video, image and audio data. Media from multiple sources in multiple forms is also indexed in a similar manner described above. Once the index is created, it can be queried in a highly nuanced manner with the preprocessing and execution described in detail above. More complex queries like Boolean, nested and time sequence queries allow for addressing a wide variety of applications that are currently only addressed manually or in a semi-automated manner.

The system described above has been implemented in connection with special-purpose software programs running on general-purpose computer platforms in which stored program instructions are executed on a processor, but it could also be implemented in whole or in part using special-purpose hardware. And while the system can be broken into the series of modules and steps shown for illustration purposes, one of ordinary skill in the art would recognize that it is also possible to combine them and/or split them differently to achieve a different breakdown.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A mixed media search system, comprising:
a first medium preprocessor responsive to digitally stored documents that are encoded according to a first media format, wherein the first medium preprocessor includes logic operative to extract symbolic attributes from dimensionally variable information in the first media format,
an indexer that is responsive to the first preprocessor and is operative to build an index that includes entries associated with symbolic attributes extracted by the first preprocessor, and
a query interface responsive to a user query and operative to execute the query against the index that includes the entries derived from symbolic attributes extracted by the first preprocessor.

2. The apparatus of claim 1,
further including a second medium preprocessor responsive to digitally stored documents that are encoded according to a second media format, wherein the second medium preprocessor includes logic operative to extract symbolic attributes from information in the second media format,
wherein the indexer is responsive to both the first and second preprocessors and is operative to build an index that includes entries associated with both symbolic attributes extracted by the first preprocessor and symbolic attributes extracted by the second preprocessor, and
wherein the query interface is operative to execute the query against the index that includes the entries derived from both symbolic attributes extracted by the first preprocessor and symbolic attributes extracted by the second preprocessor.

3. The apparatus of claim 2 further including a third medium preprocessor responsive to digitally stored documents that are encoded according to a third media format, wherein the third medium preprocessor includes logic operative to extract symbolic attributes from continuously variable information in the third media format, wherein the indexer is further responsive to the third medium processor and is operative to build an index that includes entries that are associated with symbolic attributes extracted by the third preprocessor.

4. The apparatus of claim 3 wherein the first medium preprocessor is a video preprocessor, the second medium preprocessor is a textual document preprocessor, and the third medium preprocessor is a still image preprocessor.

5. The apparatus of claim 2 wherein the first medium preprocessor is a video preprocessor and the second medium preprocessor is a textual document preprocessor.

6. The apparatus of claim 2 wherein the first preprocessor is further operative to extract metadata from stored documents that are encoded according to the first media format.

7. The apparatus of claim 2 wherein the second preprocessor is operative to extract the symbolic attributes from information in the second media format in the form of metadata from stored documents that are encoded according to the second media format.

8. The apparatus of claim 2 further including a media format detector that is operative to detect at least the first and second media formats in a received document and that is operative to provide a signal identifying a detected media format in the received document to enable the selection of one of the media preprocessors for preprocessing the received document.

9. The apparatus of claim 2 wherein the first medium preprocessor is a video preprocessor that is operative to extract visual primitive information from frames of video material from a digitally stored document.

10. The apparatus of claim 9 further including sequence detecting logic operative to detect information in sequences of video frames.

11. The apparatus of claim 2 wherein the first medium preprocessor is a video preprocessor that is operative to match reference frames with frames of video material from a digitally stored document.

12. The apparatus of claim 2 wherein the first medium preprocessor is an audio preprocessor that includes voice recognition logic operative to extract textual information from a digitally stored document that includes audio-encoded information.

13. The apparatus of claim 2 further including a manual review interface operative to associate manually generated attribute information with a digitally stored document.

14. The apparatus of claim 2 wherein the query interface further includes media-specific query preprocessing logic operative to boost query terms based on medium type information for the query terms.

15. The apparatus of claim 2 wherein the dimensionally variable information includes one of spatially, temporally, mechanically, and electromagnetically variable information.

16. The apparatus of claim 2 wherein the dimensionally variable information includes continuously variable information.

17. The apparatus of claim 2 wherein the system is operative to associate probabilistic information with extracted symbolic attributes.

18. The apparatus of claim 17 wherein the system is operative to associate confidence information with extracted symbolic attributes.
